(19) United States
(12) Patent Application Publication
(10) Pub. No.: US 2009/0085343 A1
(43) Pub. Date: Apr. 2, 2009

(54) MEMORY KEEPER KIT

(76) Inventor: William R. Burch, V, Escondido, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/238,887

(22) Filed: Sep. 26, 2008

Related U.S. Application Data
(60) Provisional application No. 60/995,504, filed on Sep. 27, 2007.

(51) Int. Cl. B42D 3/18; B42D 1/00; B42D 15/00; B65D 71/00

(52) U.S. Cl. 283/67; 206/575; 281/15.1; 283/117

(57) ABSTRACT

A memory keeper kit for recording and graphically depicting events and facts of a person's life by making notes about the facts and events in writeable cells located on one easy to review chart is presented. The system comprises a box, a scrapbook album and an elongated timeline sheet comprising a plurality of writeable pages, each page defined in part by at least one fold that joins to a successive page and each page comprising a portion of a timeline comprising a chart and a banner. The sheet comprises a life categories banner, at least one time scale banner, a news events banner, a US President banner, and a chart having vertical and horizontal parallel arranged intersecting lines imprinted thereon for defining a plurality of writeable cells for recording events and facts of a person's life.

### BENEFIT CLAIM

This application claims the benefit under 35 U.S.C. 119(e) of Provisional Patent Application No. 60/995,504, filed on Sep. 27, 2007, the entire contents of which are hereby incorporated by reference for all purposes as if fully set forth herein.

### FIELD OF THE DISCLOSURE

The present invention relates generally to techniques for recording memories and events and or for recording and graphically depicting life events and facts of an individual.

### BACKGROUND

Notebooks, fill-able calendars, diaries and journals can be used to record information. For example, there are notebooks with writeable pages which a user can fill out with personal information, notes, schedules, appointments, goals or achievements.

Further, calendars sometimes list dates and brief description of commonly known political, economical or national events, but they rarely provide a comprehensive list of dates and descriptions of events that are less known, but as much important in refreshing users'memories. Some calendars may have very few pages, and thus may allow recording only very few events. Other calendars may allow detailing numerous life events, but doing so may require a multiplicity of pages, which makes reviewing the events difficult and cumbersome. Therefore, typical calendars do not provide a convenient way for viewing and tracking a multiplicity of events.

Further, planners, diaries and calendars do not provide an easy way to communicate information about user's life events to other people. The primary focus in designing planners and calendars is to provide an efficient scheduling tool, whereas the primary focus in designing diaries is to provide a sufficient space for personal notes. However, they are not designed as a tool for recording information in such a way so that the information can be easily shared and reviewed by a group of people.

In addition, planners, diaries, calendars and notebooks are not meant to become a family heirloom.

### BRIEF DESCRIPTION OF THE DRAWINGS

In the drawings:

FIG. 1 illustrates a perspective view of a memory keeper kit;

FIG. 2 illustrates a plan view of a memory keeper kit box;

FIG. 3 illustrates a plan view of a family tree page;

FIG. 4 illustrates a perspective view of a sheet;

FIG. 5 illustrates a plan view of two pages on the sheet;

FIG. 6 illustrates a plan view of an example arrangement of a Top Time Scale banner, a News Events banner and a U.S. President banner;

FIG. 7 illustrates a plan view of an example arrangement of a Life Categories banner;

FIG. 8 illustrates a plan view of an example arrangement of a Chart, a Life Categories banner, and a Top Time Scale banner;

FIG. 9 illustrates a plan view of an example arrangement of a Story of My Decade zone, and a User Name zone;

FIG. 10 illustrates one embodiment of a method for recording and graphically depicting events and facts of a person's life.

### DETAILED DESCRIPTION

Memory keeper kits and techniques are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Structural and Functional Overview
3.0 Functional Example: Recording and Graphically Depicting Events and Facts of a Person's Life
4.0 Extensions and Alternatives

1.0 General Overview

In one embodiment, a memory keeper kit comprises a box, an elongated timeline sheet and a scrapbook album. In one embodiment, the memory kit may also comprise an audio storage and playback device.

In one embodiment, the compartment comprises a plurality of upstanding perimeter walls defining an open space sized to receive the scrapbook album and the sheet.

The box may comprise a spine, a lid and a base having a compartment. The base comprises a base left edge and a base right edge, which is opposite to the base left edge. The spine of the box may comprise a spine left edge and a spine right edge, which is opposite to the spine left edge. The lid of the box may comprise a lid left edge and a lid right edge, which is opposite to the lid left edge. The box, the spine and the lid may form a flexibly connected storage wherein the base left edge is pivotally connected to the spine right edge, and the spine left edge is pivotally connected to the lid right edge.

In one embodiment, the lid is configured and sized to pivot over and fully cover the scrapbook album and the sheet in the compartment. In one embodiment, the sheet looks like a book with the timeline individually bound.

In one embodiment, the timeline sheet comprises a plurality of writeable pages, each page defined in part by at least one fold that joins to a successive page, each page comprising a portion of a timeline comprising a chart and a banner. In one embodiment, the sheet may be configured to be folded and stored in the compartment. The pages of the sheet may be arranged in any conjoined arrangement so that each page is joined to a successive page or a previous page, or both, along at least one edge of the page. The pages of the sheet may be in a pleated fan-folded arrangement, accordion pleats, or other arrangement where the sheet is folded into pages.

The sheet may comprise a multi-year time span that covers a time span of about one hundred years. In one embodiment, the time span may be 120 years. The sheet may comprise a plurality of pages, each of the pages having a perimeter sized approximately equal to a size of the cover of the scrapbook album.

In one embodiment, the banner comprises a top time scale banner representing a multi-year period of time and having a starting year and an ending year.

In one embodiment, the banner further comprises a lifestyle categories banner that may have lifestyle categories of events and facts that people experience during their lives. The lifestyle categories may comprise information about national events indexed by the top time scale banner, and comprising examples of news events suggestive of past events and facts that are well known to the public.

In one embodiment, examples of the lifestyle categories may comprise a U.S. Presidents category, for the names of the presidents elected in the years indexed by the top time scale banner.

The chart may have vertically and horizontally arranged intersecting lines imprinted thereon and defining a plurality of writeable cells for recording events and facts of a person's life. In one embodiment, the writeable cells are horizontally indexed by the lifestyle categories banner and vertically indexed by the top time scale banner.

In one embodiment, the sheet may further comprise a story-of-my-decade zone imprinted adjacent to the chart and configured to receive written information. The sheet may also comprise a user-name zone imprinted adjacent to the chart and configured to receive user identification information.

2.0 Structural and Functional Overview

Certain embodiments as disclosed herein provide for a system, kit and method for recording and graphically depicting events and facts of a person's life. In an embodiment, the system allows the user to create a graphical depiction of a person's life events and facts on one sheet of paper in which groups of one or more years are depicted on one of a plurality of conjoined pages in the sheet, which provides a useful overview of a person's history and life experiences, and provides an heirloom that can be passed from one generation to another.

In an embodiment, a memory keeper kit is described. The purpose of the memory keeper kit is to help an individual to record a life history and create a graphical memoir of a life on a single sheet of paper comprising a plurality of conjoined pages, in which the pages are associated with periods of one or more years. In an embodiment, a method for recording and graphically depicting the events and facts of a person's life allows a user to record personal events and facts in writeable cells of a data sheet in a chronological order and according to an event type or event category. The depiction provides a useful overview of a person's history and life experiences, and can be stored in a memory keeper box.

After reading this description it will become apparent to one skilled in the art how to implement the invention in various alternative embodiments and alternative applications. However, although various embodiments of the present invention will be described herein, it is understood that these embodiments are presented by the way of example only, and not a limitation. As such, this detailed description of various alternative embodiments should not be construed to limit the scope or breadth of the present invention as set forth in the appended claims.

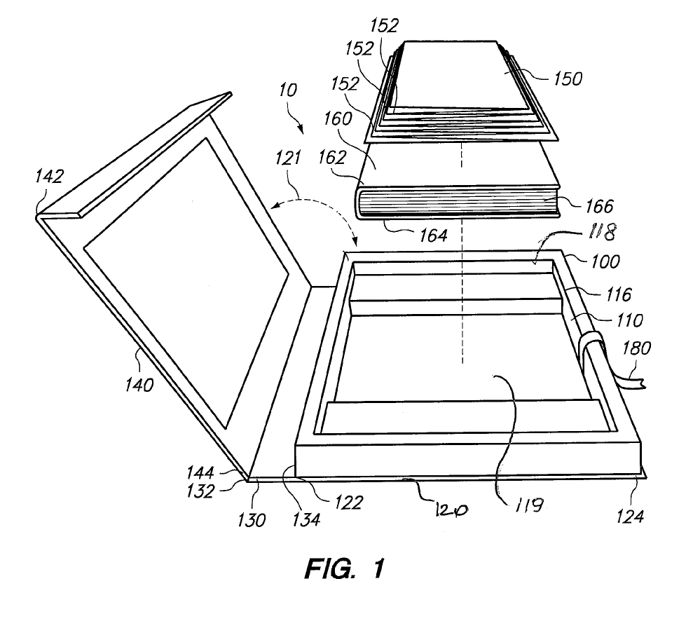

FIG. 1 illustrates a perspective view of a memory keeper kit. In the illustrated embodiment, a memory keeper kit 10 comprises a box 100, an elongated timeline sheet 150 and a scrapbook album 160. The box 100 may comprise one or more compartments 116, which can receive and store the components of the kit 10. The compartment 116 may comprise a plurality of upstanding perimeter walls 118 defining an open space 119, sized to receive, for example, the sheet 150 and the scrapbook album 160.

In an alternative embodiment, the memory keeper kit 10 may also comprise an audio storage and playback device (not depicted in FIG. 1). In such a case, the compartment 116 may comprise additional upstanding perimeter walls defining a second open space that is sized to receive the audio storage and playback device. The audio storage and playback device may be any of various audio devices, such as for example, an analog tape recorder-player, a digital recorder-player, a solid state digital music player, or a CD player.

In an embodiment, box 100 may comprise a spine 130, a lid 140 and a base 120. The base 120 may be shaped as a rectangle and may comprise a base left edge 122 and a base right edge 124, which is opposite to the base left edge 122. The base 120 may be flexibly attached to the spine 130 along the base left edge 122 using, for example, a flexible fabric, spiral rings, pins, fasteners, or adhesive. In various embodiments, box 100 can be made out of a relatively sturdy paper, carton paper, cardboard paper, plastic, metal, cloth-covered bookbinding boards, or other material capable of holding its shape and capable of withstanding minor forces or punches.

The spine 130 of the box 100 may comprise a spine left edge 132 and a spine right edge 134, which is opposite to the spine left edge 132. The spine 130 may be flexibly attached to the lid 140 along the spine left edge 132 using, for example, a flexible fabric, spiral rings, pins, fasteners, or adhesive. The spine 130, just as the box 100, can be made out of a relatively sturdy paper, carton paper, cardboard paper, plastic, metal, or cloth bookbinding boards.

The lid 140 of the box 100 may have a rectangular shape and may comprise a lid left edge 142 and a lid right edge 144, which is opposite to the lid left edge 142. The lid 140 can be made out the same materials used to manufacture the box or the spine.

A front face of the lid 140 (not depicted in FIG. 1 but forming the reverse of an inside face 141) may feature an ornamental design, graphics, or other decorative elements. Additionally or alternatively, the front face of the lid 140 may comprise basic information about the system 10, such as, a title of the system 10, or a name of the author. Designs, graphics, decorative elements or information may be printed or otherwise affixed to the front face.

Inside face of the lid 140 may comprise information about the system 10 imprinted or affixed on the inside face. The imprinted information may include a description of how to use the system 10, reasons why one may find the system useful, or quotes from several sources praising the system. In one example arrangement, the product description page may comprise a top block, a middle block and a bottom block. The top block may contain a description of the system 10, and instructions on how to use the system. The middle block may contain some helpful hints on how to get the most out of the system 10. The bottom block may contain information about the publisher, copyright or patent rights, or contact information for a product distributor.

In one embodiment, the box 100, spine 130 and lid 140 may be flexibly connected; for example, the base left edge 122 is pivotally connected to the spine right edge 134, and the spine left edge 132 is pivotally connected to the lid right edge 144. The lid 140 may be configured and sized to pivot over along a lid rotation path 121, and fully cover the scrapbook album 160 and the sheet 150 in the compartment 116. Upon closing, the lid 140 may snap to a magnetic receptacle. Alternatively, upon closing, the lid 140 may rest in a grove of the box 100. In other alternatives, other closures may be used such as locks or hook-and-loop fasteners.

In one embodiment, the timeline sheet 150 comprises a plurality of writeable conjoined pages 152. Each page 152 can have a rectangular shape, although other shapes are contemplated as well. Each of the pages may have a perimeter sized approximately equal to a size of the cover of scrapbook album 160. The pages 152 of the sheet 150 may be arranged in an accordion pleated, fan-folded arrangement, or other conjoined arrangement so that each page is joined to a successive page or a previous page, or both, along at least one edge of the page. Thus interior pages 152 may have both page edges joined to each of a previous page and a successive page. The pages 152 can be folded and stored in the compartment 116. Embodiments containing different placements and affixations of sheet 150 are also contemplated. The pages 152 may be made out of a paper capable of receiving handwritten text. Embodiments may use papers intended for long-term storage. For example, archival-quality heavyweight paper, cardstock, or cover stock may be used.

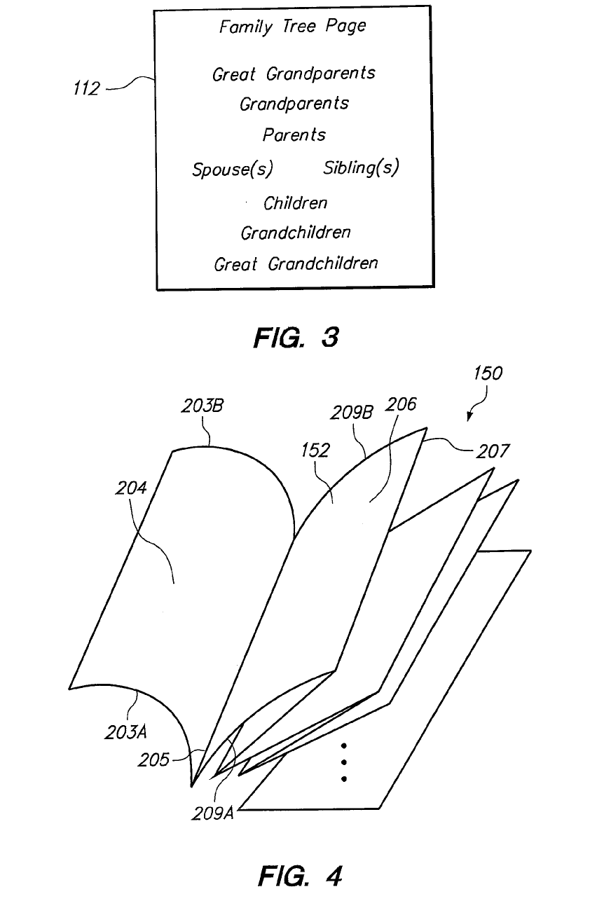

In one embodiment, one or more pages 152 of the sheet 150 may comprise a family tree page 112 as shown in FIG. 3 and further described below. The family tree 112 may comprise a graphical representation of a family tree, having fill-able cells identified by labels such as user's name, spouse's name, names of parents, grandparents, great grandparents, siblings, children, grandchildren, great grandchildren, or other relatives. The family tree page 112 may contain an ornamental design, graphics, or other decorative motifs.

In one embodiment, the sheet 150 comprises or is configured to receive data for a multi-year time span that covers a time span of about one hundred years. In one embodiment, the time span covers 120 years. With or without the family tree page 112, in this embodiment, the sheet 150 may comprise twelve (12) pages 152, wherein the first two pages are dedicated to the first decade, the third and the fourth pages are dedicated to the second decade, and the last two pages are dedicated to the tenth decade. Other time spans are also contemplated.

In one embodiment, the scrapbook album 160 may be any type of an album configured to receive photographs, clips, notes, or other materials. In an embodiment, scrapbook album 160 has a front cover 162, a back cover 164 and pages 166 extending between the front cover 162 and the back cover 164. For example, the scrapbook album 160 may have a number of pages 166 for storing photographs, clips, notes, or other materials. The pages 166 may be connected to each other and expand in an accordion pleated, fan-folded arrangement, or each page 166 may be connected to an album spine holding the covers and pages in place.

In other embodiments, the scrapbook album 160 may be a container for storing loose photographs, clips, scraps, notes, or other materials, and having the front cover 162 and the back cover 164. The scrapbook album 160 may be stored in the compartment 116. The folded sheet 150 may be stored in the compartment 116 above or below scrapbook album 160, as indicated in FIG. 1 by a broken line intersecting the base 120, the scrapbook album 160 and the sheet 150.

In one embodiment, the system 10 “closed” measures approximately 15″ width×18.75″ height×3.25″ depth, and the system 10 “open” measures approximately 35.75″ width×18.75″ height×3″ depth.

The system 10 may form a large hard-bound book that can stand on a bookshelf. In one embodiment, the spine 130 may comprise text such as a name of the system, the name of the author, a name of the publisher, a publisher's logo or other indicia.

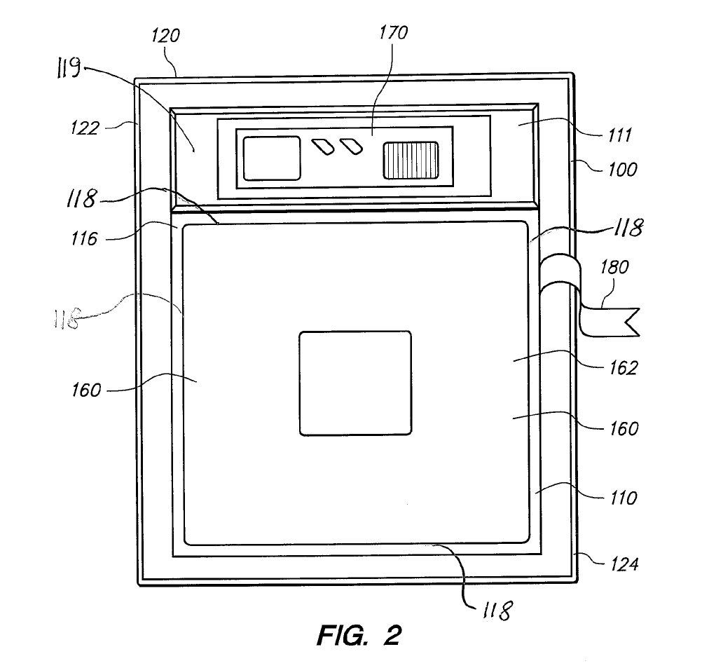

FIG. 2 illustrates a plan view of a memory keeper kit. According to the depicted embodiment, a memory keeper kit box 100 comprises base 120 with base left edge 122 and base right edge 124.

The embodiment of FIG. 2 depicts an alternative embodiment of the base 120 of FIG. 1. In contrast to FIG. 1, as shown in FIG. 2 the base 120 comprises two compartments. The first compartment comprises an album compartment 110 that is configured to receive the scrapbook album 160 and the sheet 150. The second compartment is an audio player compartment 111, and is configured to receive the audio storage and playback device 170.

In one embodiment, compartments 110, 111 are between the base left edge 122 and the base right edge 124. For example, the audio player compartment 111 may be located in an upper part of the base 120 and above the audio compartment 110.

In one embodiment, the compartments 110, 111 may be formed by a plurality of upstanding perimeter walls 118 defining an open space 119, sized to receive the scrapbook album 160, and the audio device 170. The walls 118 may be made out of a sturdy material, carton paper, or molded in a moldable material coupled with the base 120.

The compartment 110 is sized and configured to have the scrapbook album 160 placed in the compartment. The scrapbook album 160 may comprise front cover 162, back cover 164 (not depicted in FIG. 2), and pages 166 (not depicted in FIG. 2), pivotally attached to the front cover 162 and the back cover 164 and configured to receive photographs, clips, scraps, notes, or other materials. To ease removing the scrapbook album 160 from of the compartment 110, the compartment may have a lifting strip 180 attached to the compartment. The lifting strip 180 may be flexible and may comprise a piece of fabric or ribbon that is long enough so it extends out of the compartment 110, and thus it can be easily pulled out or upward to help lifting the scrapbook album 160 out of the compartment.

The audio player compartment 111 is sized and configured to receive the audio device 170. The audio device 170 may be any of various audio devices, such as for example, an analog tape recorder-player, a digital recorder-player, a solid state digital music player, or a CD player. The audio player compartment 111 may be formed to allow for a loose fitting of the audio device 170 in the audio device compartment. In one embodiment, the audio device compartment 111 may also have a lifting strip to facilitate removing the audio device 170 from the compartment.

FIG. 3 illustrates a plan view of a family tree page described above. In one embodiment, the family tree page 112 may comprise an ornamental design, graphics, or other decorative motifs.

FIG. 4 illustrates a perspective view of the sheet of FIG. 1. In the illustrated embodiment, the sheet 150 comprises a plurality of pages 152. In one embodiment, the sheet 150 may comprise a left page 204 and a right page 206, wherein the left page 204 is physically connected to the right page 206 and joined at a fold or seam 207. The left page 204 has a left page top edge 203B and a left page bottom edge 203A, whereas right page 206 has a right page top edge 209B and a left page bottom edge 209A.

In an embodiment each page, except the last page, is connected to a successive page, and each page comprises a portion of the timeline sheet 150, a chart (not depicted in FIG. 4) and a banner (not depicted in FIG. 4). In one embodiment, the pages 152 of sheet 150 may be arranged in an accordion pleated, fan-folded or otherwise conjoined, and the sheet may be configured to be stored in the compartment 116.

In one embodiment, pages 204, 206 may be dedicated to one ten-year long period of time or decade, and may be collectively called a spread. The first two pages of the sheet (the first spread) may correspond to the first decade; the subsequent two-page pair (the second spread) may form a second decade, and so forth so that a plurality of decades are represented by page pairs.

In one embodiment, the sheet 150 represents a multi-year time span that covers a time span of about one hundred years. In other embodiment, the sheet 150 represents a time span of about one hundred twenty years.

The sheet 150 may comprise a paper of a quality intended to last for many years. For example, the sheet may comprise archival paper, card stock, cover stock, or other material which is durable and also suitable to accept hand writing in pen or pencil. Material suitable for automatic recordation, mechanical printing, or electronic printing by computer, computer printer, or typewriter also may be used.

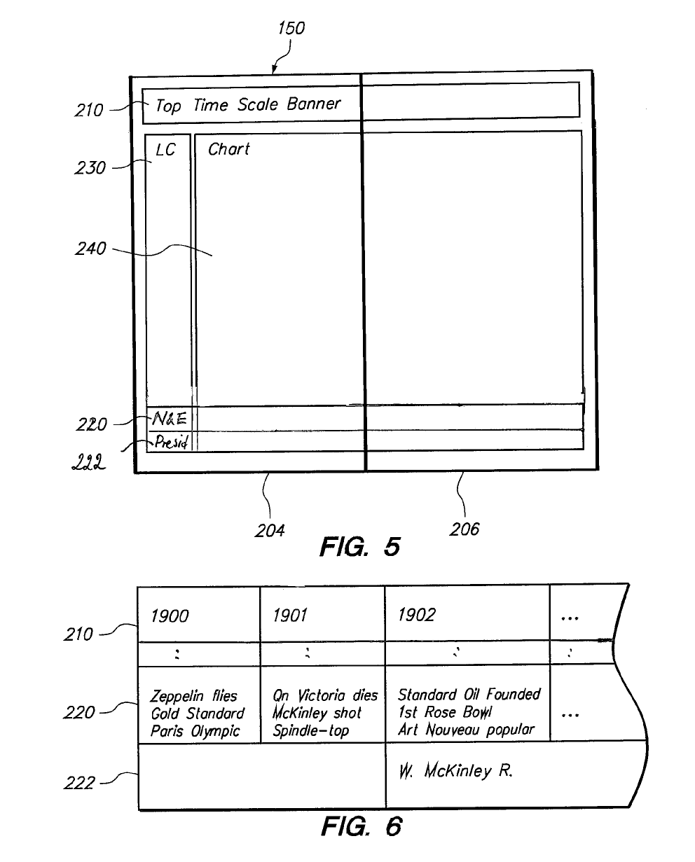

FIG. 5 illustrates a plan view of a two page spread of the sheet of FIG. 4. In the illustrated embodiment, sheet 150 comprises left page 204 and right page 206. In one embodiment, the sheet 150 comprises a plurality of pages 204, 206, connected sequentially, folded, or otherwise conjoined, and which can be expanded or unfolded so that the entirety of sheet 150 can be viewed at once. In other embodiments, the left page 204 and the right page 206 may be bound together, for example, along a left edge of each page.

In one embodiment, the sheet 150 covers a continuous period of time of one hundred twenty years, beginning with the decade of the birth of the user.

In one embodiment, the sheet 150 may cover a continuous period of time of one hundred twenty years. Embodiments may use periods of time of one hundred years, or any other useful time period.

In one embodiment, the sheet 150 comprises a Top Time Scale banner 210, a Life Categories banner 230, and a Chart 240. The sheet 150 may also comprise a Story of My Decade zone 260, and a User Name zone 280 (none of which is depicted in FIG.3).

In the illustrated embodiment, the Top Time Scale banner 210 is printed along the top edge of the sheet 150, contains a time scale along the horizontally positioned banner and covers a ten-year long time span. Other time spans or intervals of years may be used in other embodiments.

In one embodiment, the Top Time Scale banner 210 is formed by a grid having a plurality of columns intersected by one row in order to define a plurality of cells to be filled with consecutive numbers representing years of a decade.

In one embodiment, the Life Categories banner 230 comprises a variety of life categories, which a user may utilize to organize the user's own events and facts, and which are suggestive of events and facts that people experience during their lives. Alternatively, the Life Categories banner 230 banner may be left blank, allowing users to fill it with the information they consider important to them, or download the information from a website. In both embodiments, the user may modify the Life Categories banner 230 by supplementing the list with new categories or refined categories.

In one embodiment, a list of the Life Categories may be available at a website available over the Internet. The website list of the Life Categories may be updated even after the user's copy of the memory keeper kit was printed, and thus, the website list may contain additional categories that are not depicted on the Life Categories banner 230. A user may connect to the website using a conventional browser, view the website list of the Life Categories and supplement the Life Categories banner 230 with the category items from the website list of the Life Categories.

In one embodiment, the Chart 240 comprises a two-dimensional array of writeable cells 244 (depicted in detail in FIG. 8), in which a user may record personal information and data. The chart 240 is vertically indexed by the Top Time Scale banner 210 and vertically indexed by the Life Categories banner 230.

In one embodiment, examples of the lifestyle categories include News Events banner 220 containing information about various national, political and economical events. The News Events banner 220 can be indexed by the Top Time Scale banner 210, and may be chronologically arranged according to the Top Time Scale banner 210.

In one embodiment, a list of the News Events may be available at the website available over the Internet. A user may connect to the website using a conventional browser, view the website list of the News Events and supplement the News Events banner 220 with the category items from the website list of the News Events.

In one embodiment, examples of the lifestyle categories include the U.S. President banner 222 containing information about the U.S. Presidents and indexed by the Top Time Scale banner 210. The U.S. President banner 222 may be left blank, allowing users to fill it with information they consider important to them, or download the information from a website.

Information included in the News Events banner 220 and information included in the U.S. President banner 222 may be utilized by a user to refresh the user's memory and to help the user to recall personal events and facts that otherwise the user would have forgotten.

In one embodiment, the Story of My Decade zone 260 (not depicted in FIG. 5) may include user's personal information summarizing the decade of their own life. In the User's Name zone 280 (not depicted in FIG. 5), users may write down or otherwise record their own name or any additional personal identification information.

FIG. 6 illustrates a plan view of an example arrangement of the Top Time Scale banner 210, the News Events banner 220 and the U.S. President banner 222. In the illustrated embodiment, the Top Time Scale banner 210 may be used to index the News Events banner 220 and the U.S. President banner 222.

Similarly, the cell in the U.S. President banner 222 indexed by the year 1902 may contain the name of President William McKinley, who was president in the specified year.

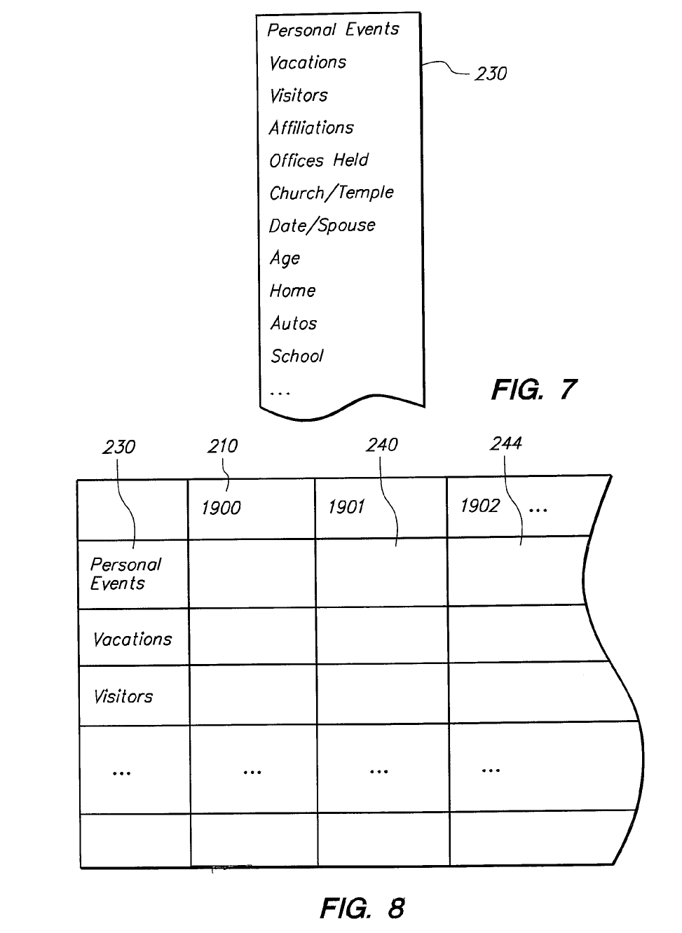

FIG. 7 illustrates a plan view of an example arrangement of the Life Categories banner 230. In the illustrated embodiment, the Life Categories banner 230 comprises a number of different life events and facts that may provide users with opportunities to record their own facts and events. Examples of life categories include, but are not limited to: Personal Events, Vacations, Visitors, Affiliations, Offices Held, Church/Temple, Date/Spouse, Age, Home, Autos, School, Jobs, Children, Grandchildren, Pets, New Friends, Hobbies, Sports, and Health.

In one embodiment, a list of the Life Categories may be available at the website described above. A user may connect to the website using a conventional browser, view the website list of the Life Categories and supplement the Life Categories banner 230 with the category items from the website list of the Life Categories.

FIG. 8 illustrates a plan view of an example arrangement of the Chart 240, the Life Categories banner 230, and the Top Time Scale banner 210. In the illustrated embodiment, the Chart 240 comprises a plurality of horizontal and vertical lines forming the writeable cells 244 indexed horizontally by the Life Categories banner 230 and vertically by both the Top Time Scale banner 210.

A user may record information about personal events and facts in the writeable cells 244 of the Chart 240. The date of a user's event and the particular category of the user's event may be used to index and locate the particular writeable cell 244 corresponding to the user's event. For example, a person who was born in 1950 may have information about her/his birth-date written on the Chart 240 that contains the year 1950, in writeable cell 244 horizontally indexed by the “Age” life category listed on the Life Category banner 230 and vertically indexed by the year 1950 line listed on the Top Time Scale banner 210.

According to another example, a person who attended Kindergarten at “River View Elementary” school in 1956 may have the information about attending “River View Elementary” school written on the Chart 240 that contains the year 1956, in the writeable cell 244 horizontally indexed by the “School” life category listed on the Life Category banner 230 and vertically indexed by the year 1956 line listed on the Top Time Scale banner 210.

According to another example, a person who started attending the “Holy Cross Lutheran” church in 1970 may have the information about attending the “Holy Cross Lutheran” church written on the Chart 240 that contains the year 1970, in the writeable cell 244 horizontally indexed by the “Church” life category listed on the Life Category banner 230 and vertically indexed by the year 1970 line listed on the Top Time Scale banner 210.

As the user continues recording information about various areas of the user's life, the user may start recalling additional events and facts. Eventually, the user may fill out a number of Charts 240.

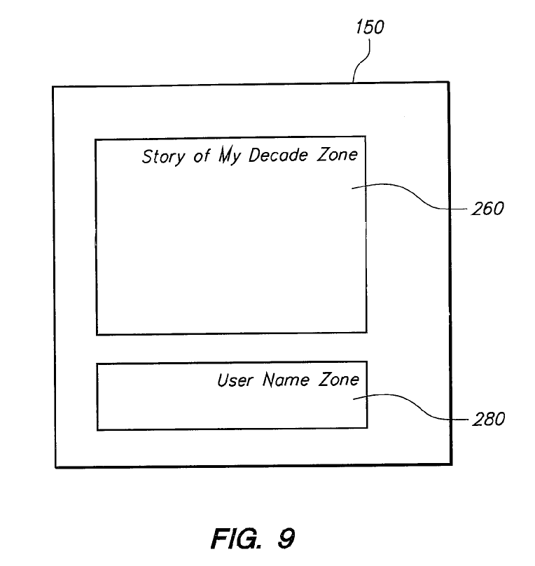

FIG. 9 illustrates a plan view of an example arrangement of the Story of My Decade zone 260, and a User's Name zone 280. In the illustrated embodiment, the Story of My Decade zone 260, and the User's Name zone 280 are imprinted on one of the pages of the sheet. A user may use the Story of My Decade zone 260 to record information about essential events and facts that took place during the decade to which the sheet is dedicated. In one embodiment, the Story of My Decade zone 260 focuses the user on some of the highlights of the decade, and not necessarily to create a journal or diary.

In one embodiment, the user may record the user's name in the User's Name zone 280. The User's Name zone 280 may be also used to provide other identification information, notes, or other data.

3.0 Functional Example: Recording and Graphically Depicting Events and Facts of a Person's Life

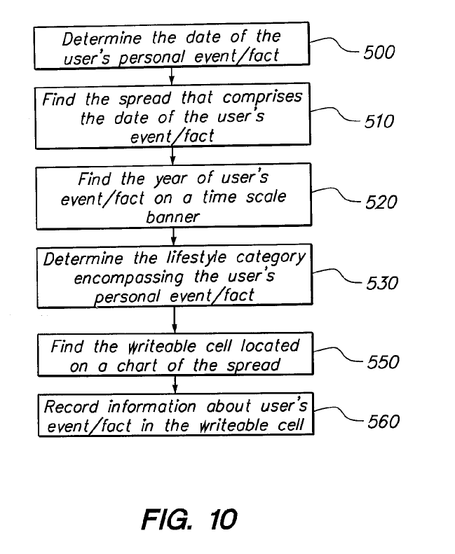

FIG. 10 illustrates one embodiment of a method for recording and graphically depicting events and facts of a person's life according to an embodiment of the present invention.

In the illustrated embodiment, at a step 500, a user who wants to record a particular personal event or fact, determines the year in which the user's personal event or fact occurred.

In step 510, the user finds a spread comprising two or more pages of a sheet that comprises the year in which the user's personal event or fact occurred.

At step 520, the user locates the year of the personal event or fact on a Top Time Scale banner of the spread corresponding to the year in which a user's personal event or fact occurred.

At step 530, the user determines a category from the Life Categories banner located on the spread that encompasses the personal event or fact. The Life categories banner may list various life categories, such as, Personal Events, Vacations, Visitors, Affiliations, Offices Held, Church/Temple, Date/Spouse, Age, Home, Autos, School, Jobs, Children, Grandchildren, Pets, New Friends, Hobbies, Sports, or Health.

In step 550, the user locates a writeable cell located on the chart of the spread, which is positioned at the intersection of the row extending horizontally from the life category cell and the column extending vertically from the year cell.

In step 560, the user records the information about her/his personal event or fact in the writeable cell identified in the previous step.

Once the user finds the appropriate writeable cell, the user may record or write down information about a personal event or fact. The writeable cell should be properly indexed by the date of the personal event or fact and the proper life category, which encompasses the event or fact. For example, a person who was born in 1950 will first find the proper spread which contains the year 1950. Then, the user will find the life category labeled as “Age.” Then, in the writeable cell vertically indexed by the year 1950 column, and horizontally indexed by the “Age” life category, the user may write down “0.” Subsequently, the user may write down or record “1” in the writeable cell vertically indexed by the year 1951 column and the horizontally indexed by the “Age” life category.

According to another example, a person who attended “River View Elementary” in 1956, may want to first find the spread that contains the year 1956, and then, in the writeable cell horizontally indexed by the “School” life category and vertically indexed by the year 1956 column, the user may write down or record the information about her/his “Elementary, River View.”

Further, according to another example, a person who started attending the “Holy Cross Lutheran” in 1970 may want to first find the spread that contains the year 1970. Then, in the space horizontally indexed by the “Church/Temple” life category line and vertically indexed by the year 1970 column, the user may write down the information 'Holy Cross Lutheran.”

In other embodiment, the user may refer to a News Events banner, and/or a U.S. President banner to refresh the user's memory and recall events that otherwise the user might have forgotten. For example, the user may first review the News Event banner on the spread to help her/him to recall personal events and facts. For example, the cells of the News Events banner 220 indexed by the year 1929 may include the following information: “Stock market crashes,” “1^{st} Academy Awards,” “Decade of growth ends,” etc. The user may also review the U.S. President banner on the spread to help her/him to recall own personal events and facts. For example, the cell in the U.S. President banner 222 indexed by the year 1929 may contain the name of President Herbert Hoover.

As the user enters the data, the user may also write down or record the story of a decade in the Story of my Decade zone. In one embodiment, each spread may contain one Story of my Decade zone.

In one embodiment, the user may login to a website on the Internet and review updated lists of the Life categories, the News Events lists and the U.S. Presidents lists. The user may refer to the updated lists, copy the items from the lists to own sheets and continue filling out the writeable cells of the sheet.

4.0 Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

For example, whenever this disclosure refers to a user performing an action, the referenced action may be performed by a person other than the user. For example, one person may record information on behalf of another person who is the subject of the memory keeper kit.

Further, whenever this disclosure refers to writing down information, the referenced information may be recorded using automatic, mechanical, electronic, or computer means. For example, information may be recorded by computer printing.

What is claimed is:

1. A system, comprising in combination:
a box, comprising a spine, a lid and a base comprising a compartment;
an elongated timeline sheet comprising a plurality of writeable pages, each defined in part by at least one fold that joins to a successive page, each page comprising a portion of a timeline comprising a chart and a banner;
a scrapbook album;
wherein the base has a base left edge and a base right edge, which is opposite to the base left edge; wherein the spine has a spine left edge and a spine right edge, which is opposite to the spine left edge; wherein the lid has a lid left edge and a lid right edge, which is opposite to the lid left edge; wherein the base left edge is pivotally connected to the spine right edge, and the spine left edge is pivotally connected to the lid right edge.

2. The system of claim 1, wherein the sheet is configured to be folded and stored in the compartment.

3. The system of claim 1, wherein the sheet comprises a multi-year time span that covers a time span of about one hundred years.

4. The system of claim 1, wherein the sheet comprises 25 or more pages, each of the pages having a perimeter sized approximately equal to a size of a cover of the scrapbook album.

5. The system of claim 1, wherein the banner comprises a lifestyle categories banner having lifestyle categories of events and facts that people experience during their lives.

6. The system of claim 1, wherein the banner further comprises a top time scale banner representing a ten-year period of time and having a starting year and an ending year; and
a news events banner having information about national events indexed by the top time scale banner, and wherein the news event banner comprises examples of news events suggestive of past events and facts that are well known to the public.

7. The system of claim 1, wherein the banner further comprises a U.S. President banner comprising names of U.S. Presidents elected in the years indexed by the top time scale banner.

8. The system of claim 1, wherein the chart has vertically and horizontally arranged intersecting lines imprinted thereon and defining a plurality of writeable cells for recording events and facts of a person's life; and wherein the writeable cells are horizontally indexed by the lifestyle categories banner and vertically indexed by the top time scale banner.

9. The system of claim 1, wherein the sheet further comprises a story-of-my-decade zone imprinted adjacent to the chart and configured to receive written information.

10. The system of claim 1, wherein the sheet further comprises a user name zone imprinted adjacent to the chart and configured to receive identification information.

11. The system of claim 1, wherein the compartment comprises a plurality of upstanding perimeter walls defining an open space sized to receive the scrapbook album and the sheet.

12. The system of claim 1, wherein the lid is configured and sized to pivot over and fully cover the scrapbook album and the sheet in the compartment.

13. The system of claim 1, further comprising an audio storage and playback device.

14. A method for recording and graphically depicting events and facts of a person's life, comprising:
determining a year in which a personal event occurred;
finding a page of a sheet that comprises the year in which the personal event occurred;
locating on a top time scale banner of the sheet the year in which the personal event occurred;
determining a category from a lifestyle categories banner located on the sheet, the category encompassing the user's personal event;
locating a writeable cell located on a chart of the sheet, the writeable cell positioned at the intersection of the lifestyle category row extending horizontally from the lifestyle category and the year column extending vertically from the year; and
recording information about the personal event in the writeable cell located on the chart of the spread.

15. The method of claim 14, further comprising reviewing a news event banner on the spread to help a user to recall personal events and facts.

16. The method of claim 14, further comprising reviewing a U.S. President banner on the spread to help to recall other personal events and facts.

17. The method of claim 14, further comprising reviewing data entered on other lifestyle categories lines, to help to recall other personal events and facts.

18. A kit, comprising in combination:
a box, comprising a spine, a lid and a base comprising a compartment;
an elongated timeline sheet in the box and comprising a plurality of writeable pages, each defined in part by at least one fold that joins to a successive page, each page comprising a portion of a timeline comprising a chart and a banner;
a scrapbook album in the box;
wherein the base has a base left edge and a base right edge, which is opposite to the base left edge; wherein the spine has a spine left edge and a spine right edge, which is opposite to the spine left edge; wherein the lid has a lid left edge and a lid right edge, which is opposite to the lid left edge; wherein the base left edge is pivotally connected to the spine right edge, and the spine left edge is pivotally connected to the lid right edge; wherein the sheet comprises 25 or more pages, each of the pages having a perimeter sized approximately equal to a size of a cover or the scrapbook album; wherein the sheet is configured to be folded and stored in the compartment; wherein the compartment comprises a plurality of upstanding perimeter walls defining an open space sized to receive the scrapbook album and the sheet; and wherein the lid is configured and sized to pivot over and fully cover the scrapbook album and the sheet in the compartment.

19. The kit of claim 18, wherein the sheet is bound as a book.

20. The kit of claim 18, wherein the chart has vertically and horizontally arranged intersecting lines imprinted thereon and defining a plurality of writeable cells for recording events and facts of a person's life.
